(19) United States
(12) Patent Application Publication
(10) Pub. No.: US 2004/0180689 A1
(43) Pub. Date: Sep. 16, 2004

(54) Systems and methods for establishing communication between a first wireless terminal and a second wireless terminal differing in respect to at least one feature

(75) Inventor: Narasimha K. Nayak, Glen Allen, VA (US)

Correspondence Address: Finnegan, Henderson, Farabow,, Garrett & Dunner, L.L.P., 1300 I Street, N.W., Washington, DC, 20005-3315, US

(73) Assignee: LogicaCMG Wireless Networks, Inc.

(21) Appl. No.: 10/698,550

(22) Filed: Nov. 3, 2003

Related U.S. Application Data
(60) Provisional application No. 60/454,331, filed on Mar. 14, 2003.

(51) Int. Cl. H04M 1/00

(52) U.S. Cl. 455/552.1

(57) ABSTRACT

Communication between a first wireless terminal and a second wireless terminal, where the first wireless terminal may have at least one feature that the second wireless terminal may not have, is established. In one specific example, the at least one feature may relate to a video call capability. Thus, for example, the second wireless terminal may not be capable of handling a video call. In that case, the communication between the first wireless terminal and the second wireless terminal may be downgraded to a voice communication.

### DESCRIPTION OF THE INVENTION

This application claims priority under 35 U.S.C. § 119 based on U.S. Provisional Application No. 60/454,331, filed Mar. 14, 2003, the complete disclosure of which is incorporated herein by reference.

### FIELD OF THE INVENTION

This invention relates to communications systems and methods, and more particularly, it relates to systems and methods for establishing communication between a first wireless terminal and a second wireless terminal differing in respect to at least one feature.

### BACKGROUND OF THE INVENTION

Wireless cellular telecommunication systems have evolved from analog systems, such as AMPS and TACS to digital systems, such as CDMA, TDMA, and GSM. These first two generations of wireless cellular telecommunication systems are now being replaced by the third generation systems (also referred to as 3G systems). While the first generation of wireless cellular telecommunication systems largely focused on providing voice communications, the second generation targeted data communications, as well. The third generation aims for handling richer content, such as multimedia and video telephony. Third generation wireless cellular telecommunication systems are expected to bring high-speed wireless connectivity to cellular communications enabling new applications, such as video telephony.

Evolution from one generation of wireless cellular telecommunication systems to another, however, has been problematic in terms of providing support for various features associated with various wireless terminals, such as mobile phone handsets. Thus, for example, while the third generation compatible mobile phone handsets can support video telephony, the earlier generation compatible mobile phone handsets cannot support video telephony. Currently proposed third generation wireless cellular telecommunication systems handle incompatibility between features supported by various mobile phone handsets rather ungracefully. For example, such proposals specify that when a wireless call is placed by a video-capable mobile phone handset to a voice-only mobile phone handset, the wireless call is not completed.

Accordingly, there is a need for systems and methods for handling feature differences between third generation wireless terminals and earlier generation wireless terminals.

### SUMMARY OF THE INVENTION

In accordance with the invention, systems and methods for establishing communication between a first wireless terminal and a second wireless terminal, where the first wireless terminal may have at least one feature that the second wireless terminal may not have are provided. In one example, at least one feature may relate to a video call capability. Thus, for example, the second wireless terminal may not be capable of handling a video call. In that case, the exemplary method may include downgrading the communication between the first wireless terminal and the second wireless terminal to a voice communication when it is determined that the second wireless terminal does not have the video call capability.

Accordingly, one exemplary embodiment of the present invention relates to a method for establishing communication between a first wireless terminal and a second wireless terminal, wherein the first wireless terminal may have at least one functional capability that the second wireless terminal may not have. The exemplary method may include receiving a signal to establish a communication between the first wireless terminal and the second wireless terminal from the first wireless terminal, wherein the communication includes use of the at least one functional capability that the second wireless terminal may not have. The method may further include determining whether the second wireless terminal has the at least one functional capability.

The exemplary method may further include establishing the communication between the first wireless terminal and the second wireless terminal including use of the at least one functional capability, when it is determined that the second wireless terminal has the at least one functional capability. Alternatively, when it is determined that the second wireless terminal does not have the at least one functional capability, the exemplary method may include establishing the communication between the first wireless terminal and the second wireless terminal without the use of the at least one functional capability.

In another embodiment consistent with the present invention, a method for establishing communication between a first wireless terminal and a second wireless terminal is provided. The method may include receiving a call signal from the first wireless terminal to establish a video session between the first wireless terminal and the second wireless terminal. The method may further include querying a database to determine whether the second wireless terminal has a video capability. The method may further include forwarding the call to a video gateway, if the second wireless terminal does not have the video capability. The method may further include setting up a video session between the first wireless terminal and a video server.

In yet another embodiment consistent with the present invention, a system for establishing communication between a first wireless terminal and a second wireless terminal is provided. The system may include at least one mobile switching center for receiving a call signal from the first wireless terminal to establish at least one video session between the first wireless terminal and the second wireless terminal. The system may further include at least one call processing module for querying at least one of a home location register and a visitor location register to determine whether the second wireless terminal has a video capability, for setting up at least one video session between the first wireless terminal and a video server, and for setting up a non-video session between the first wireless terminal and the second wireless terminal.

In a still another embodiment consistent with the present invention, a method for establishing communications between terminals in a wireless system is provided. The method may include receiving a signal to establish a call between a call originating terminal and a call receiving terminal. The method may further include establishing, as a function of call processing functionality available to the call receiving terminal, the call between the call originating terminal and the call receiving terminal.

In yet another embodiment consistent with the present invention, a method for connecting calls between terminals in a wireless system having a plurality of terminals for processing calls, where any differences in call processing functionality between the terminals may not be known to associated users when initiating calls, is provided. The method may include an originating terminal initiating a new call for a terminating terminal, the new call reflecting call processing functionality available to the originating terminal regardless of call processing functionality available to the terminating terminal and invoked when placing the new call. The method may further include at least one of the originating terminal and the terminating terminal making adjustments required to establish the new call if the new call requires specific call processing functionality not available to the terminating terminal.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate various embodiments of the invention and together with the description, serve to explain the principles of the invention. In the drawings,

FIG. 1 shows one embodiment of an exemplary system for establishing communication between a first wireless terminal and a second wireless terminal consistent with the present invention;

FIG. 2 shows one embodiment of a mobile switching center with a call management module consistent with the present invention;

FIG. 3 shows another embodiment of an exemplary system for establishing communication between a first wireless terminal and a second wireless terminal consistent with the present invention;

FIG. 4 shows one embodiment of a video gateway with a video call module consistent with the present invention;

FIG. 5 shows a flow chart for an exemplary method for establishing communication between a first wireless terminal and a second wireless terminal consistent with the present invention;

FIG. 6 shows a flow chart for another exemplary method for establishing communication between a first wireless terminal and a second wireless terminal consistent with the present invention;

FIG. 7 shows a flow chart for an exemplary method for connecting calls between terminals consistent with the present invention; and

FIG. 8 shows a flow chart for another exemplary method for connecting calls between terminals consistent with the present invention.

### DETAILED DESCRIPTION

In accordance with the invention, systems and methods for establishing communication between wireless terminals that potentially support different functionality are provided. In one configuration, a first wireless terminal may support audio and video calls and a second wireless terminal may support audio calls but not video calls. When the first wireless terminal is used to make a video call to the second wireless terminal, systems and methods consistent with the invention, downgrade the communication between the first wireless terminal and the second wireless terminal to an audio only call upon determination that the second wireless terminal does not have the video call capability. In another configuration, the first wireless terminal may support multimedia processing and the second wireless terminal may not support multimedia processing.

Reference will now be made in detail to the exemplary embodiments of the invention, examples of which are illustrated in the accompanying drawings. Wherever possible, the same reference numbers will be used throughout the drawings to refer to the same or like parts.

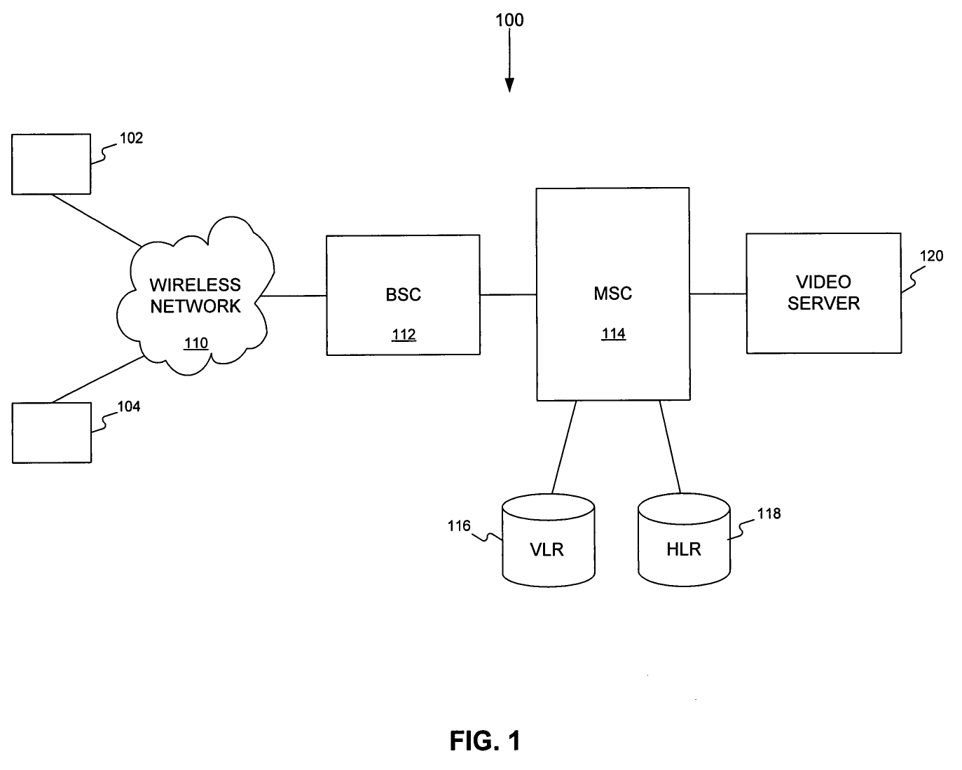

FIG. 1 shows an exemplary system 100 consistent with one embodiment of the present invention. As shown, exemplary system 100 may include wireless terminals 102 and 104 connected to a base station controller (BSC) 112 via a wireless network 110. In one embodiment, base station controller 112 may be any base station controller that can support the third generation wireless cellular telecommunications systems, such as the Univity CDMA Base Station Controller available from Nortel Networks Corporation of Brampton, Ontario, Canada. Base station controller 112 may further be connected to a mobile switching center (MSC) 114. An exemplary mobile switching center may be DMS Mobile Switching Center, which may be obtained from Nortel Networks Corporation of Brampton, Ontario, Canada. Mobile switching center 114 may set up communication between wireless terminals using a control channel, for example. Mobile switching center 114 may be connected to a visitor location register 116 (VLR) and a home location register (HLR) 118. HLR 118 may be a database used to store information concerning a wireless terminal's user, such as account status and user preferences. In one embodiment, HLR 118 may further store information concerning a wireless terminal's functionality. Wireless terminal functionalities stored in HLR 118 may relate to whether a particular wireless terminal can handle video calls or process multimedia, for example. HLR 118 may also contain information that uniquely identifies a particular wireless terminal, such as its International Mobile Subscriber Number (IMSI) or its Electronic Serial Number (ESN). VLR 116 may be a database used to store similar information concerning roaming users. Although FIG. 1 shows only one exemplary base station controller and one mobile switching center, one may have additional base station controllers and/or mobile switching centers. Further, the functionality of a base station controller and a mobile switching center may be combined in one component. Similarly, exemplary system 100 may include additional home location and visitor location registers.

In addition, mobile switching center 114 may be coupled to a video server 120. In one embodiment, video server 120 may be implemented on a computer manufactured by Sun Microsystems, Inc., running, for example, the Solaris® operating system. Video server 120 may play a pre-recorded video greeting to a user of a video-enabled wireless terminal. Video server 120 may also record a video message from one wireless terminal user to another wireless terminal user, which could be played later. Indeed, other application programs and operating systems permitting voice and video file processing may also be used consistent with the present invention.

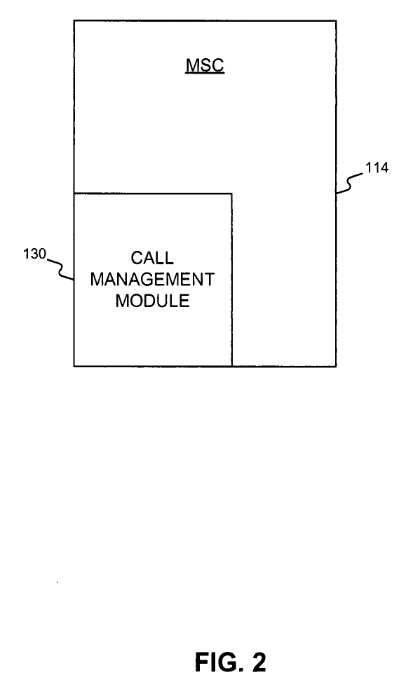

As shown in FIG. 2, in one embodiment, mobile switching center (MSC) 114 may include a call management module 130, which may be used consistent with the method for establishing communication between a first wireless terminal and a second wireless terminal. Call management module 130 may be a software module, a hardware module, or a combination of software and hardware. The first wireless terminal's user may initiate a call resulting in a call signal being transmitted from the first wireless terminal to base station controller 112. Base station controller 112 may forward the call signal to mobile switching center 114, which may further process the signal, including forwarding the call signal to call management module 130. Upon receiving a call signal from the first wireless terminal to establish a communication between the first wireless terminal and the second wireless terminal, wherein the communication includes use of the at least one feature that the second wireless terminal may not have, call management module 130 may query VLR 116, HLR 118, or both to determine whether the second wireless terminal has the at least one call processing functionality, for example, the capability to handle video calls.

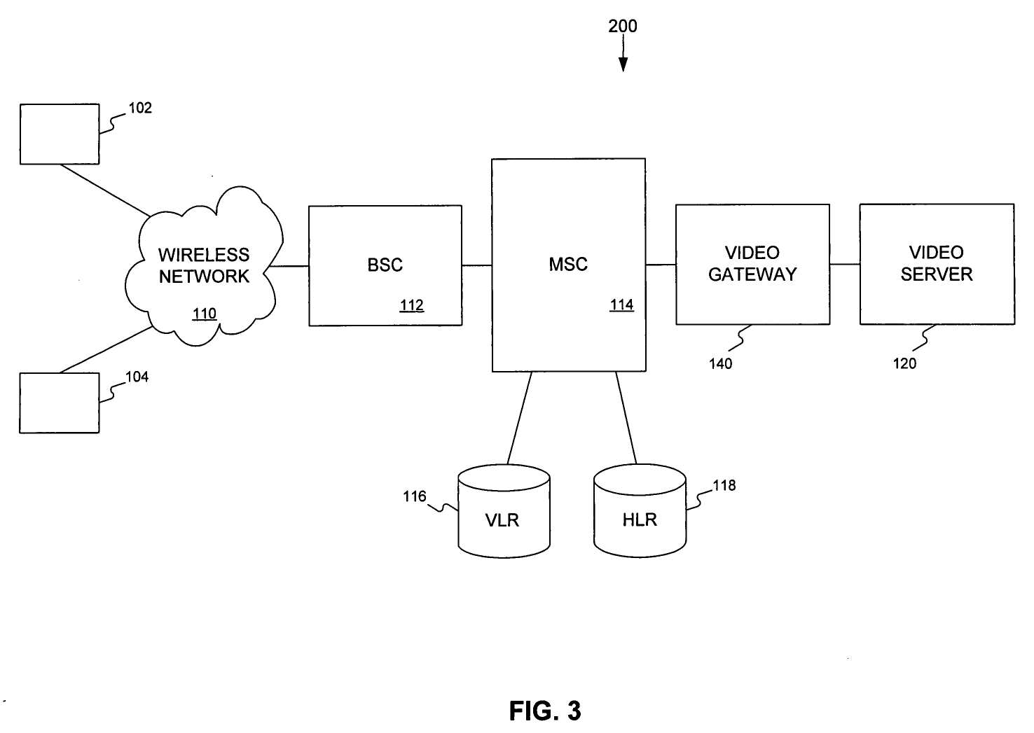

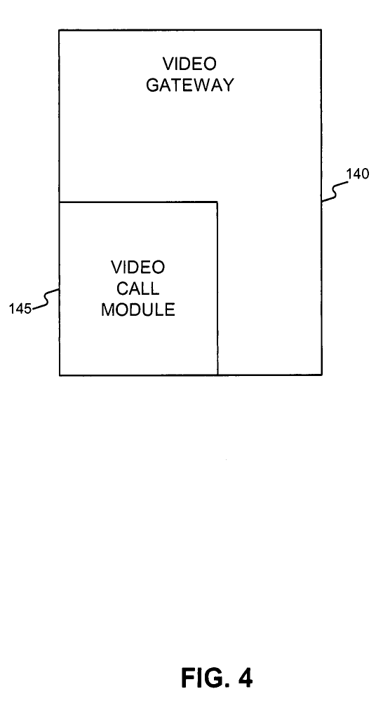

FIG. 3 shows another exemplary system environment 200 consistent with the present invention. The exemplary system environment 200 may include a first wireless terminal 102 and a second wireless terminal 104 connected via a wireless network 110 to a base station controller 112. Base station controller 112 may further be connected to a mobile switching center 114, which may further be coupled to a VLR 116 and a HLR 118. Mobile switching center 114 may be connected to a video gateway 140, which further may be coupled to a video server 120. Consistent with this exemplary embodiment, video gateway 140 may further include a video call module 145, as shown in FIG. 4. In one embodiment, video gateway 140 may be implemented using a video gateway made by Ericsson of Stockholm, Sweden. In this embodiment, mobile switching center 114 may forward the call signal from a call originating terminal to video call module 145, which may query VLR 116, HLR 118, or both to determine whether the call receiving wireless terminal has the at least one call processing functionality, for example, the capability to handle video calls. Video gateway 140 may also convert one type of signal (for example, a lower bandwidth wireless signal) into another type of signal (for example, a higher bandwidth landline signal).

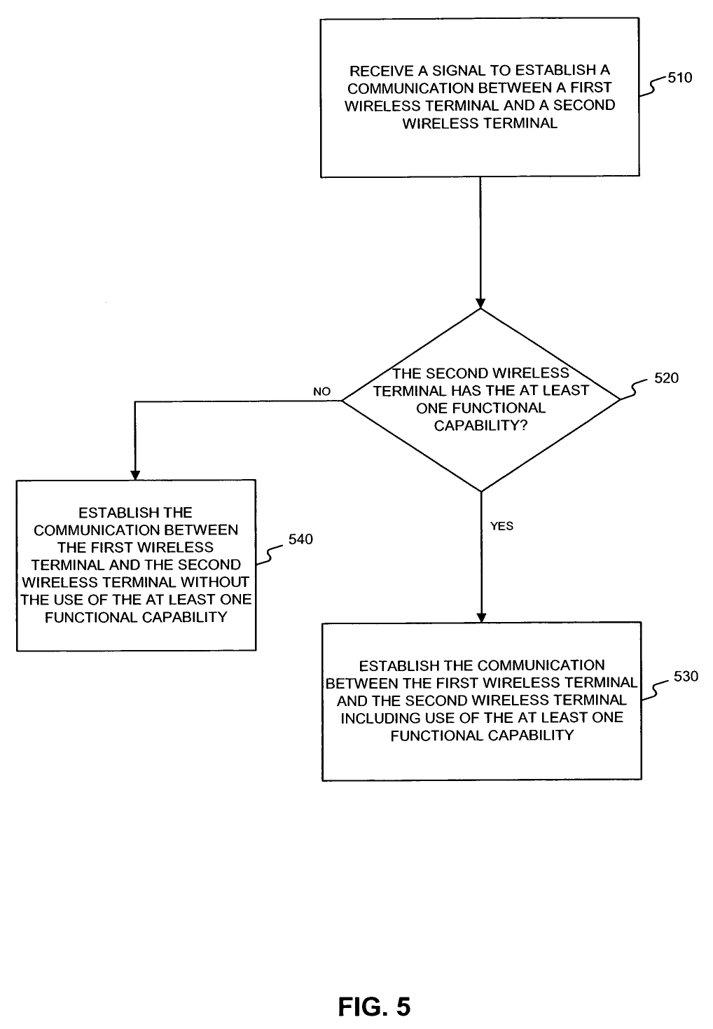

FIG. 5 shows a flow chart for an exemplary method, consistent with this invention, for establishing communication between a first wireless terminal and a second wireless terminal. For illustrative purposes, the first wireless terminal may originate a call signal to establish a call between the first wireless terminal and the second wireless terminal. The call signal may be received by a base station controller 112, which may then forward the call signal to a mobile switching center 114. Thus, the first step of the method may involve a call processing module 130 or a video call module 145, depending upon the system configuration in use, receiving a signal to establish a communication between a first wireless terminal and a second wireless terminal, wherein the first wireless terminal may have at least one functional capability that the second wireless terminal may not have (step 510). In one embodiment, the first wireless terminal may be a H.324m protocol (a standard protocol from International Telecommunications Union, located at Geneva Switzerland) or 3G-324 protocol compliant mobile phone handset. Of course, any other wireless terminal that can handle video calls may also be used.

The next step may involve either call management module 130 of FIG. 2 or video call module 145 of FIG. 4, depending upon the system configuration in use, determining whether the second wireless terminal has the at least one functional capability (step 520). In one aspect of the invention, call management module 130 or video call module 145 may query either VLR database 116 or HLR database 118 to determine the second wireless terminal's capabilities. Alternatively, some other database or databases may be queried to determine the second wireless terminal's capabilities. In one embodiment, VLR database 116 or HLR database 118 may be queried by using the International Mobile Subscriber Number (IMSI) associated with a particular wireless terminal, such as the second wireless terminal. Of course, other fields, such as an Electronic Serial Number (ESN) associated with a wireless terminal may also be used to query the relevant database(s).

The exemplary method may further include establishing the communication between the first wireless terminal and the second wireless terminal including use of the at least one functional capability where the second wireless terminal is determined to have the at least one functional capability (step 530). In one embodiment the subject functional capability is video call handling. In other words, a determination is made as to whether the second wireless terminal is a video phone. If it is determined that the second wireless terminal cannot handle video calls, then the exemplary method may include establishing the communication between the first wireless terminal and the second wireless terminal without the use of the at least one functional capability (step 540). That is, a voice call is established between the terminals. As part of this step, either call management module 130 of FIG. 2 or video call module 145 of FIG. 4, depending upon the system configuration in use, may cooperate with mobile switching center 114, base station controller 112, and other components of the wireless system to establish the voice call between the terminals.

To connect a voice call in this situation, the communication between the first wireless terminal and the second wireless terminal may be downgraded. In one embodiment, downgrading may comprise splitting the communication between the first wireless terminal and the second wireless terminal into two streams. The first stream may be a voice only stream between the first wireless terminal and the second wireless terminal, whereas the second stream may be a video stream between the first wireless terminal and a video server, such as video server 120 of FIG. 1. In one embodiment, video server 120 may generate a video or a picture and forward that to mobile switching center 114 for transmission to a user of the first wireless terminal. The video or the picture may indicate to the user of the first wireless terminal that a voice call, for example, is being established between the first wireless terminal and the second wireless terminal.

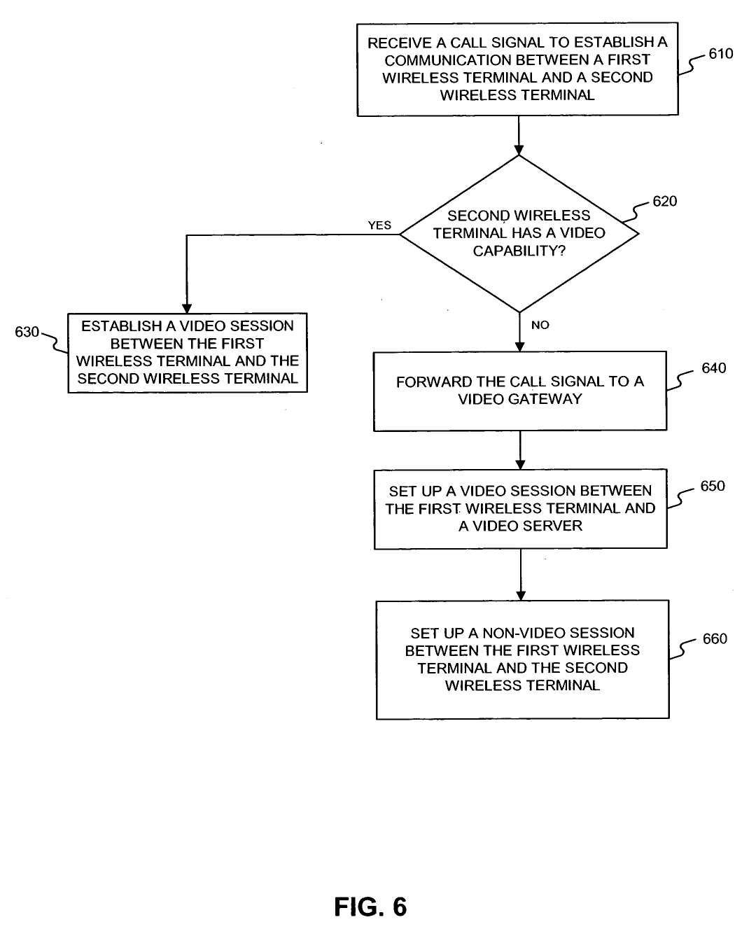

FIG. 6 shows a flowchart, consistent with this invention, for an exemplary method for establishing a video session between a first wireless terminal and a second wireless terminal. The exemplary method may include call management module 130 or video call module 145, depending upon the system configuration in use, receiving a call signal to establish a communication between a first wireless terminal and a second wireless terminal (step 610). In one embodiment, the first wireless terminal may be a H.324m or 3G-324 protocol compliant mobile phone handset. Any other wireless terminal that can handle video calls may also be used.

The next step may involve determining whether the second wireless terminal has a video capability (step 620). If so, then a video session may be established between the first wireless terminal and the second wireless terminal (step 630). If not, or in other words, if the second wireless terminal is voice capable only, for example, then the exemplary method may include forwarding the call signal to a video gateway (step 640). In one embodiment, the call signal may be forwarded by mobile switching center 114 to video gateway 140. In one embodiment, mobile switching center 114 may use an Initial User Part-Initial Address Message (ISUP-IAM) message, a signaling system 7 (SS7) signal, to forward the call signal to the video gateway. Other signaling or messaging methods may also be used to forward the call signal to video gateway 140.

Video gateway 140may then set up a video session between the first wireless terminal and video server 120 (step 650). As part of this step video gateway 140 may convert communication signals from one protocol to another. For example, video gateway 140 may convert wireless signals in the H.324m format to Session Initiation Protocol (SIP) (an Internet Engineering Task Force standard) or H.323 format (an International Telecommunications Union Standard). In one embodiment, video server 120 may generate a video or a picture and forward that to video gateway 140 for transmission to a user of the first wireless terrminal. The video or the picture may indicate to the user of the first wireless terminal that a voice call, for example, is being established between the first wireless terminal and the second wireless terminal.

Video server 120 may also be used to record a video message from the user of the first wireless terminal to the user of the second wireless terminal. The mobile switching center 114 or video gateway 140, depending upon the system configuration in use, may also set up a non-video session between the first wireless terminal and the second wireless terminal (step 660). In one embodiment, this may include mobile switching center 114 sending a signal to the second wireless terminal on a control channel. If the second wireless terminal does not answer then the call session may be ended. If, however, the second wireless terminal answers, then call management module 130 of FIG. 2 or video call module 145 of FIG. 4 may set up a voice channel between the first wireless terminal and the second wireless terminal. Other components of a MSC, BSC, or other parts of a wireless network may play a role in establishing the connection between the two wireless terminals.

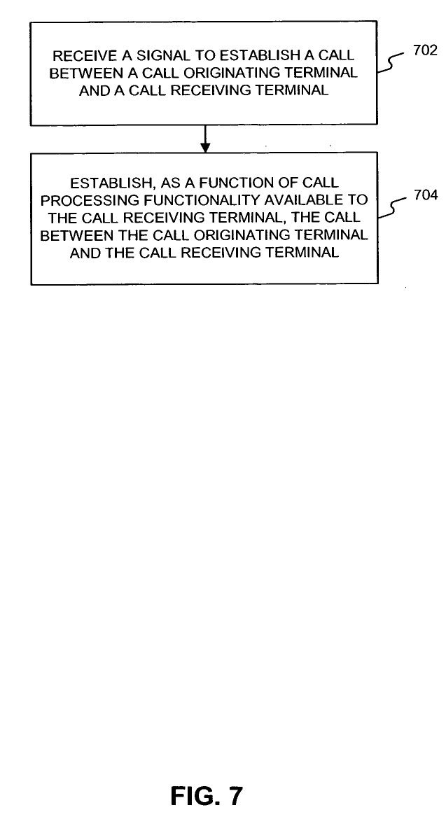

FIG. 7 shows a flow chart for an exemplary method for connecting calls between terminals. The exemplary method may be implemented in a wireless system having a plurality of terminals for processing calls (such as shown in FIG. 1 and FIG. 3), where any differences in call processing functionality between the terminals may not be known to associated users when initiating calls. The method may include the wireless system receiving a signal to establish a call between a call originating terminal and a call receiving terminal (step 702). In one embodiment, the signal may be received by base station controller 112, which may forward the signal to mobile switching center 114, as discussed above with respect to step 510 of FIG. 5.

Call management module 130 or video call module 145, depending on the system configuration in use, may establish, as a function of call processing functionality available to the call receiving terminal, the call between the call originating terminal and the call receiving terminal (step 704). Thus, for example, where the call receiving terminal has the requisite call processing functionality then a call including the use of the call processing functionality may be established between the call originating terminal and the call receiving terminal in a manner similar to step 530 of FIG. 5. Alternatively, if the call receiving terminal does not have the call processing functionality, a call without the use of the call processing functionality may be established between the call originating terminal and the call receiving terminal in a manner similar to step 540 of FIG. 5.

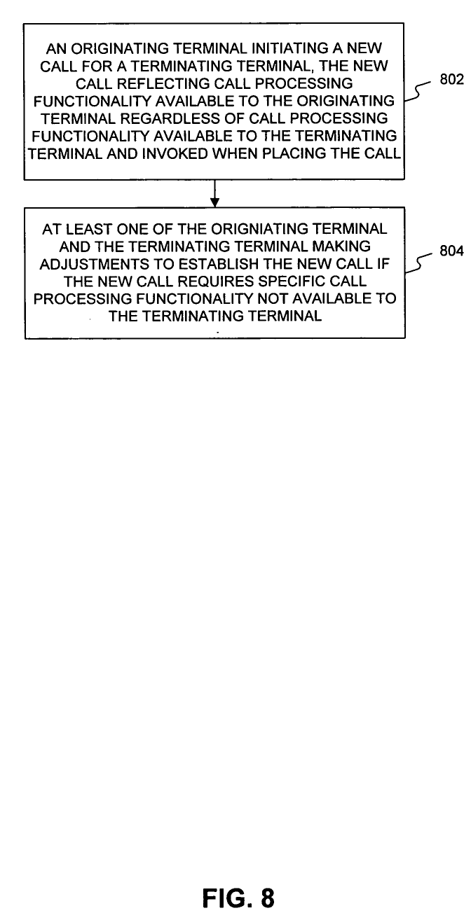

FIG. 8 shows a flow chart for another exemplary method for connecting calls between terminals. The exemplary method may be implemented in a wireless system having a plurality of terminals for processing calls (such as shown in FIG. 1 and FIG. 3), where any differences in call processing functionality between the terminals may not be known to associated users when initiating calls. The method may include an originating terminal initiating a new call for a terminating terminal, the new call reflecting call processing functionality available to the originating terminal regardless of call processing functionality available to the terminating terminal and invoked when placing the new call (step 802). In one embodiment, the signal may be received by base station controller 112, which may forward the signal to mobile switching center 114, as discussed above with respect to step 510 of FIG. 5.

At least one of the originating terminal and the terminating terminal may make adjustments to establish the new call, if the new call requires specific call processing functionality not available to the terminating terminal (step 804). In one embodiment, either the originating terminal or the terminating terminal may communicate with call management module 130 or video call module 145, depending on the system configuration in use, to indicate to them that the terminating terminal does not have the specific call processing functionality required by the new call. As discussed above with respect to step 540 of FIG. 5, either call management module 130 of FIG. 2 or video call module 145 of FIG. 4, depending upon the system configuration in use, may cooperate with mobile switching center 114, base station controller 112, and other components of the wireless system to establish a call without the specific call processing functionality between the terminals, for example.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for establishing communication between a first wireless terminal and a second wireless terminal, wherein the first wireless terminal may have at least one functional capability that the second wireless terminal may not have, the method comprising:
receiving a signal from the first wireless terminal to establish a communication between the first wireless terminal and the second wireless terminal, wherein the communication includes use of the at least one functional capability that the second wireless terminal may not have;
determining whether the second wireless terminal has the at least one functional capability; and
establishing the communication between the first wireless terminal and the second wireless terminal including use of the at least one functional capability, when it is determined that the second wireless terminal has the at least one functional capability.

2. The method of claim 1 further comprising establishing the communication between the first wireless terminal and the second wireless terminal without the use of the at least one functional capability, when it is determined that the second wireless terminal does not have the at least one functional capability.

3. The method of claim 2, wherein the at least one functional capability includes at least one of video call capability and multimedia capability.

4. The method of claim 2 further comprising:
downgrading the communication between the first wireless terminal and the second wireless terminal to voice communication when it is determined that the second wireless terminal does not have the at least one functional capability.

5. The method of claim 4 further comprising:
downgrading the communication by splitting the communication into two streams.

6. The method of claim 5, wherein the two streams comprise a voice only stream between the first wireless terminal and the second wireless terminal and a video stream between the first wireless terminal and a video server.

7. The method of claim 5, further comprising forwarding the signal to a video gateway and setting up a video stream between the first wireless terminal and a video server.

8. A system for establishing communication between a first wireless terminal and a second wireless terminal, wherein the first wireless terminal may have at least one functional capability that the second wireless terminal may not have, the system comprising:
means for receiving a signal from the first wireless terminal to establish a communication between the first wireless terminal and the second wireless terminal, wherein the communication includes use of the at least one functional capability that the second wireless terminal may not have;
means for determining whether the second wireless terminal has the at least one functional capability; and
means for establishing the communication between the first wireless terminal and the second wireless terminal including use of the at least one functional capability, when it is determined that the second wireless terminal has the at least one functional capability.

9. The system of claim 8, wherein the means for establishing communication between the first wireless terminal and the second wireless terminal establishes a communication between the first wireless terminal and the second wireless terminal without the use of the at least one functional capability, when it is determined that the second wireless terminal does not have the at least one functional capability.

10. The system of claim 9, wherein the at least one functional capability includes at least one of video call capability and multimedia capability.

11. The system of claim 9 further comprising:
means for downgrading the communication between the first wireless terminal and the second wireless terminal to voice communication when it is determined that the second wireless terminal does not have the at least one functional capability.

12. The system of claim 11, wherein the means for downgrading the communication downgrades the communication by splitting the communication into two streams.

13. The system of claim 12, wherein the two streams comprise a voice only stream between the first wireless terminal and the second wireless terminal and a video stream between the first wireless terminal and a video server.

14. The system of claim 12 further comprising:
means for forwarding the signal to a video gateway; and
means for setting up a video session between the first wireless terminal and a video server.

15. A method for establishing communication between a first wireless terminal and a second wireless terminal, the method comprising:
receiving a call signal from the first wireless terminal to establish a video session between the first wireless terminal and the second wireless terminal;
querying a database to determine whether the second wireless terminal has video capability;
if the second wireless terminal does not have video capability, then forwarding the call signal to a video gateway;
setting up a video session between the first wireless terminal and a video server; and
setting up a non-video session between the first wireless terminal and the second wireless terminal.

16. The method of claim 15 further comprising the video server playing a video announcement for the first wireless terminal informing the first wireless terminal of a lack of the video capability in the second wireless terminal.

17. The method of claim 15, wherein the database is at least one of a home location register and a visitor location register.

18. A system for establishing communication between a first wireless terminal and a second wireless terminal, the system comprising:
means for receiving a call signal from the first wireless terminal to establish a video session between the first wireless terminal and the second wireless terminal;
means for querying a database to determine whether the second wireless terminal has video capability;
means for setting up a video session between the first wireless terminal and a video server; and
means for setting up a non-video session between the first wireless terminal and the second wireless terminal.

19. The system of claim 18 further comprising means for playing a video announcement for the first wireless terminal informing the first wireless terminal of a lack of the video capability in the second wireless terminal.

20. The system of claim 18, wherein the database is at least one of a home location register and a visitor location register.

21. A system for establishing communication between a first wireless terminal and a second wireless terminal, the system comprising:
at least one mobile switching center for receiving a call signal from the first wireless terminal to establish at least one video session between the first wireless terminal and the second wireless terminal;
at least one call processing module for querying at least one of a home location register and a visitor location register to determine whether the second wireless terminal has a video capability, for setting up at least one video session between the first wireless terminal and a video server, and for setting up at least one non-video session between the first wireless terminal and the second wireless terminal.

22. The system of claim 21, wherein the at least one call processing module is resident in the at least one mobile switching center.

23. The system of claim 21, wherein the at least one call processing, module is resident in a video gateway.

24. A method for establishing communications between terminals in a wireless system, the method comprising:
receiving a signal to establish a call between a call originating terminal and a call receiving terminal; and
establishing, as a function of call processing functionality available to the call receiving terminal, the call between the call originating terminal and the call receiving terminal.

25. The method of claim 24, wherein establishing the communication between the call originating terminal and the call receiving terminal further comprises establishing the call without the use of at least one call processing capability, when it is determined that the call receiving terminal does not have the at least one call processing capability.

26. The method of claim 24, wherein establishing the communication between the call originating terminal and the call receiving terminal further comprises establishing the call without the use of at least one call processing capability, when it is determined that the call initially requires a call processing capability not available to the call receiving terminal.

27. The method of claim 24, wherein establishing the communication between the call originating terminal and the call receiving terminal further comprises establishing the call without the use of video call capability, when the call originating terminal has video call capability, but the call receiving terminal does not have video call capability.

28. The method of claim 25, wherein the at least one call processing capability includes at least one of video call capability and multimedia capability.

29. The method of claim 25 further comprising:
downgrading the communication between the call originating terminal and the call receiving terminal to voice communication when it is determined that the call receiving terminal does not have the at least one call processing capability.

30. The method of claim 29 further comprising:
downgrading the communication by splitting the communication into two streams.

31. The method of claim 30, wherein the two streams comprise a voice only stream between the call originating terminal and the call receiving terminal and a video stream between the call originating terminal and a video server.

32. The method of claim 30, further comprising forwarding the signal to a video gateway and setting up a video stream between the call originating terminal and a video server.

33. In a wireless system having a plurality of terminals for processing calls, wherein any differences in call processing functionality between the terminals may not be known to associated users when initiating calls, a method for connecting calls between terminals comprising:
establishing a new call between an originating terminal and a terminating terminal, the new call reflecting call processing functionality available to the originating terminal regardless of call processing functionality available to the terminating terminal and invoked when placing the new call, such that any adjustments required to establish the new call are made if the new call requires specific call processing functionality not available to the terminating terminal.

34. In a wireless system having a plurality of terminals for processing calls, wherein any differences in call processing functionality between the terminals may not be known to associated users when initiating calls, a method for connecting calls between terminals comprising:
an originating terminal initiating a new call for a terminating terminal, the new call reflecting call processing functionality available to the originating terminal regardless of call processing functionality available to the terminating terminal and invoked when placing the new call;
the terminating terminal making adjustments required to establish the new call if the new call requires specific call processing functionality not available to the terminating terminal.
